(19) United States
(12) Patent Application Publication
(10) Pub. No.: US 2007/0000179 A1
(43) Pub. Date: Jan. 4, 2007

(54) Sliding door comprising a guide for a door leaf

(75) Inventors: Dieter Krohn, Wakendorf (DE); Guenter Hoedike, Pinneberg (DE)

Correspondence Address: Kenneth L Mitchell;Woodling Crost and Rust, 9213 Chillicothe Road, Kirkland, OH, 44094, US

(73) Assignee: HOEDTKE GmbH Co. KG Metall-und Lasertechnik, Pinneberg (DE)

(21) Appl. No.: 10/566,072

(22) PCT Filed: Jul. 29, 2004
(86) PCT No.: PCT/EP04/08505

§ 371 Date: Sep. 6, 2006

(30) Foreign Application Priority Data
Jul. 29, 2003 (DE) 103 34 870.0

(51) Int. Cl. E05D 15/10

(52) U.S. Cl. 49/449; 49/209

(57) ABSTRACT

Disclosed is a sliding door (10) comprising a guide (16, 18) for a door leaf (14) which is movable within said guide (16, 18) between an open position and a closed position, and a locking device that locks the door leaf (14) in the closed position by means of frictional engagement. The locking device is provided with driving means (42), force transmitting means (54) that cooperate with the driving means (42), locking elements (80), and movement transducers (58) which move the locking elements (80). The locking elements (80) are displaced from a free position that releases the door leaf (14) into a holding position which maintains the door leaf (14) in frictional engagement.

The invention pertains to a sliding door with a guide for a door leaf according to the introductory clause of Claim 1 and to the use of this sliding door according to Claim 23 as a safety door, which resists certain gas pressures when in the closed position.

Sliding doors of various designs are known, and they are used for a wide variety of purposes. The known sliding doors have a guide for a door leaf, which can slide in the guide between an open position and a closed position. A locking device is also provided, which firmly locks the door in the closed position. A frame can be provided, which covers at least part of the edge area of the first and/or second side of the door leaf when the door leaf is in the closed position. For this purpose, the frame has a frame part for the first side of the door leaf and a frame part for the second side.

The problem with the known sliding doors is that it is very difficult to lock them in the closed position so that they are gas-tight. In many cases, the locking elements of the locking device engage in assigned openings to block the movement of the sliding door, i.e., to prevent the door from moving from the closed position to an open position. The sliding door is therefore locked in a positive manner. It is hardly possible, however, to achieve a seal in the area where the locking elements engage in the openings. In addition, the locking devices occupy a large amount of space.

Especially in the aerospace field, sliding doors are in increasing demand because of their space-saving properties. Nevertheless, it has been impossible so far to use designs of this type, because sliding doors cannot be closed gas-tight and/or because they cannot withstand certain gas pressures and high heat.

A sliding door of the general type in question is known from DE 2 302 105 A. This sliding door has a door leaf with rollers, which can roll along a rail-like profile serving as a guide between an open position and a closed position. In addition, a locking device in the form of a spreading mechanism is disclosed. This mechanism is hinged to support bodies by two tabs, which are mounted on the spreading bodies, located on each side. Because the two support bodies are able to move relative to each other, the spreading bodies move away from each other when the distance between the two support bodies is reduced and move toward each other when the distance between the two support bodies is increased. The two support bodies are able to move relative to each other because each support body is designed as the spindle nut of a spindle drive, the spindle of which is installed in a horizontal position between the two spreading bodies. The support bodies are mounted rotatably on the spindle and are supported against a stop bushing by an axial roller bearing, the bushing being permanently connected to the spindle. The spreading bodies lift a threshold profile, which in turn lifts the door leaf and pushes it against the ceiling. As a result, the gaps between the door leaf and the floor and ceiling are sealed.

A sliding door with sealing strips on both sides of a door leaf is known from DE 1 948 390 B. When the panels forming the filling of the door leaf are deflected sufficiently, a friction-locking connection is established between the door leaf and the frame.

A sliding door with a door leaf which has a frame on both sides is also known from U.S. Pat. No. 4,370,831 A. A spring, which can hold the door leaf in place by friction when needed, is actuated by electromagnets.

DE 1 158 690 describes a sealable sliding gate, which travels on rollers. An elastic seal extends all the way around the periphery. In the closed position, a movement of the gate leaf transversely to the sliding direction applies pressure to the seal. The guide rollers run in trough-like guide rails of the type conventionally used for sliding gates. The rollers are located above and below the gate leaf and rotate around vertical axes, which are supported in eccentric bushings. These eccentric bushings allow the gate to be displaced into the sealing position transversely to the normal sliding direction.

The invention is based on the task of improving a sliding door with a guide for a door leaf according to the introductory clause of Claim 1 in such a way that, first, the conditions are created under which the leaf can be locked securely in the closed position, and, second, the possibility is created of sealing the door leaf in a gas-tight manner when in the closed position.

This task is accomplished by the characterizing features of Claim 1 in conjunction with features of the introductory clause.

The subclaims describe advantageous elaborations of the invention.

The invention is based on the realization that a sliding door can be easily locked securely and sealed gas-tight in the closed position of the door leaf by means of a nonpositive connection.

According to the invention, a frame is provided, which, when the door leaf is in the closed position, at least partially covers the edge areas of the door leaf on the first and/or second side of the door leaf. Under the action of the force-transmitting means and the drive means, furthermore, the motion converter can be moved in a first direction relative to the periphery of the frame, parallel to one side of the door leaf, as a result of which it moves the locking elements in a direction perpendicular to the first direction from the free position to the hold position, whereas, when the motion converter is moved in the other peripheral direction, it moves the locking elements from the hold position to the free position.

As a result of this design, it is not only easy to provide several locking elements in the sliding door and to connect them to each other but also to operate them uniformly. When the drive means is actuated, therefore, the door leaf is pressed uniformly and simultaneously at all points against the stop means. This is a favorable design especially with respect to achieving the desired leak-tightness of the door. The stop means and the door are subjected to uniform load all along their edges.

According to a first embodiment of the invention, the frame has in particular a frame part assigned to the first side of the door leaf. In addition, stop means for the door leaf, which act in a direction perpendicular to the sliding direction of the door leaf, are introduced into this first frame part. The locking device therefore presses the door leaf, when in the locked state, against the stop means in a direction perpendicular to the sliding direction of the door leaf, so that the first side of the door leaf rests by a friction-locking connection against the stop means and thus remains locked in its closed position.

To guarantee a compact and tamper-proof locking device, the locking elements of the locking device are installed in the second frame part, which is assigned to the second side of the door leaf. When the leaf is locked, this second frame part presses the leaf against the stop means in the first frame part.

Designing the frame so that it covers the entire peripheral edge area of both the first and second sides of the door leaf not only improves the protection against tampering but also increases the freedom with which measures can be designed to seal the sliding door. In this case, for example, part of the guide will be located inside the frame. As a result, the door leaf can be pushed into the frame and pulled out of it again while it remains in the guide. The frame serves primarily to carry the stop means on one side of the arrangement and to carry the locking device, which locks the door leaf in the closed position, on the other side. Additional design elements can also be installed in the frame surrounding the edges of the door leaf, especially security elements for specific functional conditions of the sliding door, as will be explained further below.

Each motion converter preferably comprises a guide. The locking element is supported in the second frame so that it cannot move in the direction parallel to the plane of the door leaf but can slide between the free position and the hold position in the direction perpendicular to the plane of the leaf. The locking element is connected to the guide of the motion converter, so that, when the movement converter moves in one peripheral direction, the guide moves the locking element out of the free position and into the hold position, and when the converter moves in the other direction, the guide moves the locking element out of the hold position and into the free position. Strong forces can be transmitted in this way, and the door leaf can thus be pressed tightly against the stop means. In addition, this embodiment also offers a space-saving design, which withstands the load cycles caused by the continuous opening and closing of the door leaf.

For certain applications, it is advantageous for the drive means to be formed by a handle, which is actuated by the user. In this case, it is advantageous for the user, who wants to move the door leaf from its open position to its closed position and to lock it there, to be able to detect when, during the closing movement, the locking device reaches its end position. The two end positions of the locking device are the free position and the hold position. For this purpose, the guide of the motion converter preferably guides the locking element across a slack point shortly before at least one of the end points is reached. The user is then able to perceive by way of the handle when the end position has been reached. This slack point can be formed in the guide in such a way that the locking elements press against the door leaf more strongly here than they do upon reaching their end position, in this case the hold position.

According to an embodiment of the invention, the force-transmitting means is designed as a link chain, to which the drive means is connected by a pinion. To avoid frictional forces from developing between the door leaf and the locking element during the pressing process, the locking element is designed as a rotatably supported roller, which comprises in particular a maintenance-free ball bearing.

According to an embodiment of the invention, the stop means have a seal, so that a sealed closure can be produced between the one side of the door leaf and the other side.

When the door leaf is in the closed position and the locking elements are in the hold position, the seal lies on the edge area of the first side of the door leaf, so that it extends around the entire periphery and thus seals off the first side of the door leaf completely from the second side of the door leaf. As a result, certain requirements on the gas-tightness of the sliding door in the closed position can be fulfilled.

The seal can consist of an elastomer. From the standpoint of fire safety, it can be advantageous for the seal to be accompanied by a fire blocker, which prevents the seal from developing leaks under the effects of heat and fire in the known manner.

To facilitate its installation, the seal can take the form of a tape, which is introduced into a groove in the first frame part.

To improve the sealing properties even more, the door leaf can be provided with a sealing lip to cooperate with the seal, especially a lip of welded-on metal wire such as titanium wire.

According to an embodiment of the invention, the frame is made of titanium sheet. As a result, a very strong structure can be obtained, and requirements which specify that the sliding door be low in weight can also be fulfilled.

Detachable retaining means are preferably provided to hold the door leaf in the open position. As soon as a certain force on the door leaf acting in the direction toward the closed position of the door leaf is exceeded, however, these retaining means allow the door leaf to slide toward the closed position. This measure prevents the door from sliding by itself from the open position into the closed position under the effect of vibrations, for example.

In the construction of certain aircraft, there is a need to accommodate sleeping containers in the lower deck of the aircraft. These sleeping containers must be accessible from a space through which people can walk. A sliding door according to the present invention is suitable as a door between the sleeping container and the walkable space. A safety device is required to ensure that the sliding door leading to the sleeping container can be opened from one side, such as from the kitchen of the aircraft, only when a sleeping container is actually present in the storage space of the aircraft.

According to an embodiment of the invention, therefore, a safety sensor is provided, which blocks the locking device when an object such as the previously mentioned sleeping container has been removed from its position next to the door. The safety sensor can have a spring-loaded feeler, which is connected to the force-transmitting device. The feeler is pretensioned against the force of the spring when the object, e.g., the sleeping container, is present and thus releases the force-transmitting means. When the object is not present, the force of the spring moves the safety sensor into an end position in which it blocks the force-transmitting means of the locking device. As a result, the door is blocked by simple means and cannot be opened.

To obtain a good, effective seal, it is also necessary for the door leaf to be in its completely closed position.

According to an embodiment of the invention, therefore, a blocking device which allows the door leaf to be locked only when it is in the closed position is provided.

According to the invention, the sliding door with one or more of the previously mentioned features is used as a safety door, which resists certain gas pressures in the closed position. In particular, the gas pressures are in the range of 150-3,500 Pa.

The pressures indicated above are pressure differentials between the space in front of the sliding door and the space behind it.

The sliding door is preferably fireproof and meets the requirements of Airbus Standard ABD 0031, which prescribes that a door must resist burn-through for over 5 minutes at 1,000° C.

Additional advantages and possible applications of the present invention can be derived from the following description in conjunction with the exemplary embodiments, which are illustrated in the drawings.

The terms and associated reference numbers contained in the list of reference numbers given below are used in the specification, in the claims, in the abstract, and in the drawings. In the drawings,

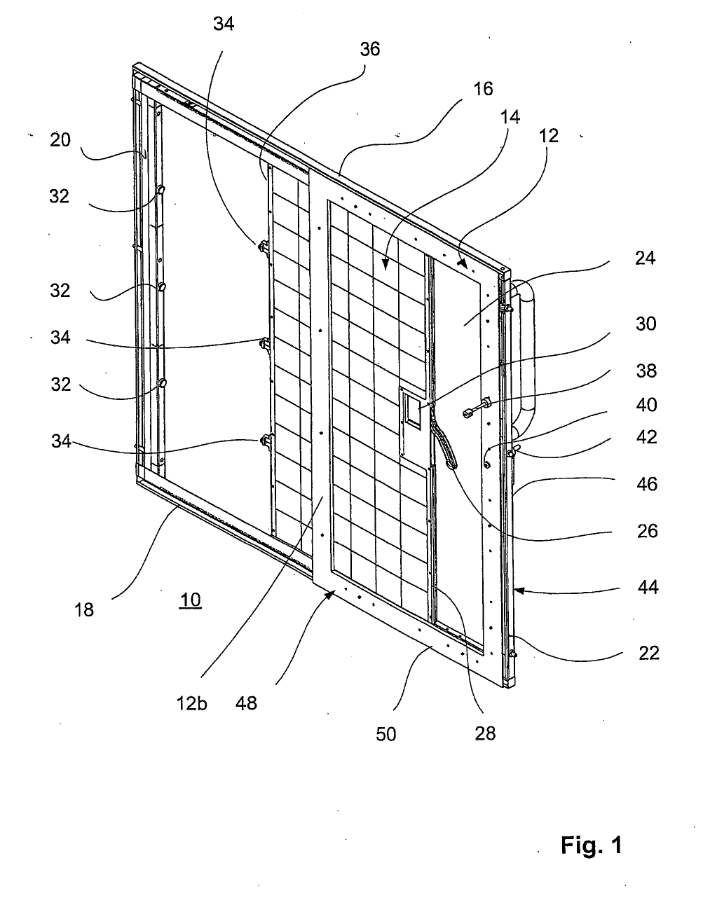

FIG. 1 shows a schematic diagram, in perspective, of a sliding door with guides, lateral stringers, and a frame;

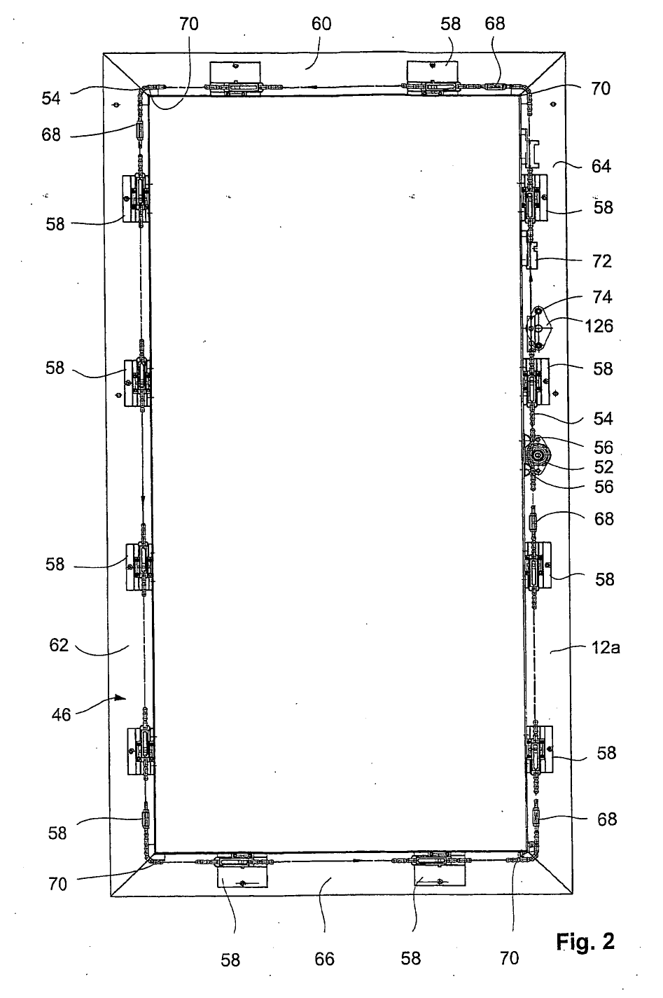

FIG. 2 shows a longitudinal cross section of the second frame part of the frame, in which a locking device for the door leaf of the sliding door is installed;

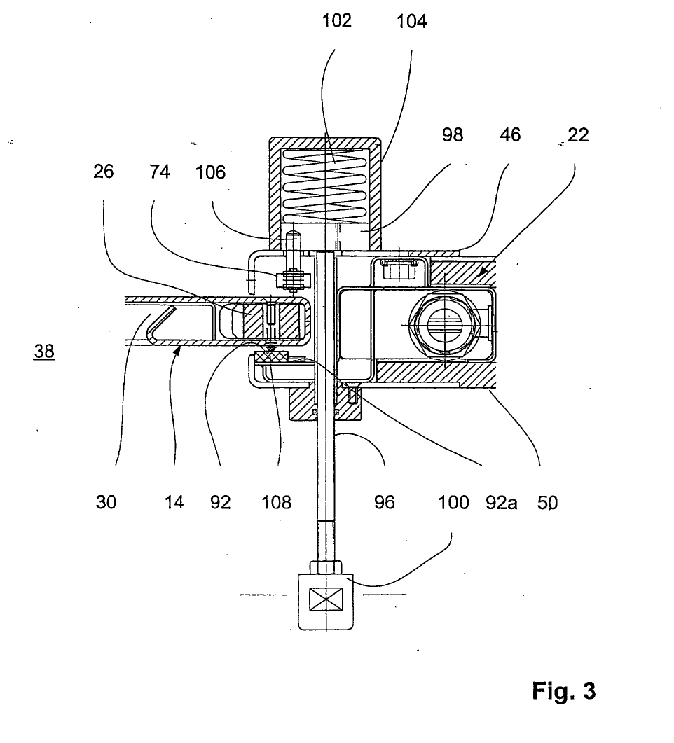

FIG. 3 shows a transverse cross section of a safety sensor mounted in the frame in the closed position of the door leaf of the sliding door;

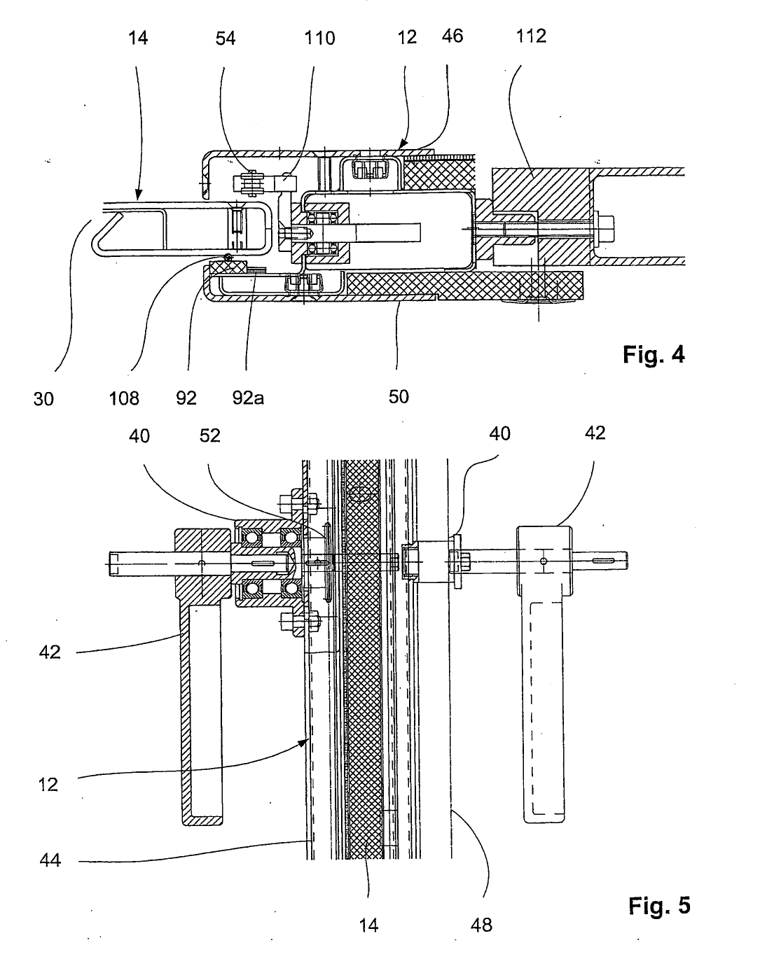

FIG. 4 shows a transverse cross section through a longitudinal frame part (stringer) of the frame in the closed position of the door leaf, which is equipped with a sensor;

FIG. 5 shows a longitudinal cross section through the frame with a handle as part of the locking device and with a door leaf in the closed position;

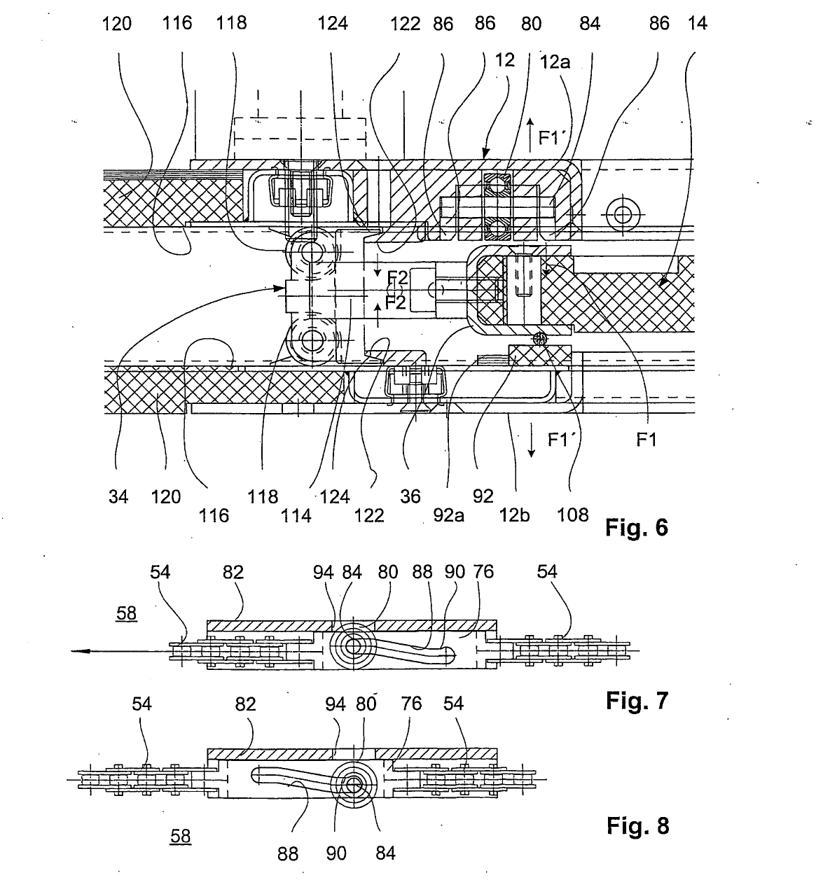

FIG. 6 shows a transverse cross section through a longitudinal frame part (stringer) of the frame, in which the edge of the door leaf one the side facing away from the handle engages when in the closed position;

FIG. 7 shows a longitudinal cross section through a motion converter, which forms part of the locking device, with the locking element in the free position;

FIG. 8 shows a longitudinal cross section through a motion converter, which forms part of the locking device, with the locking element in the hold position;

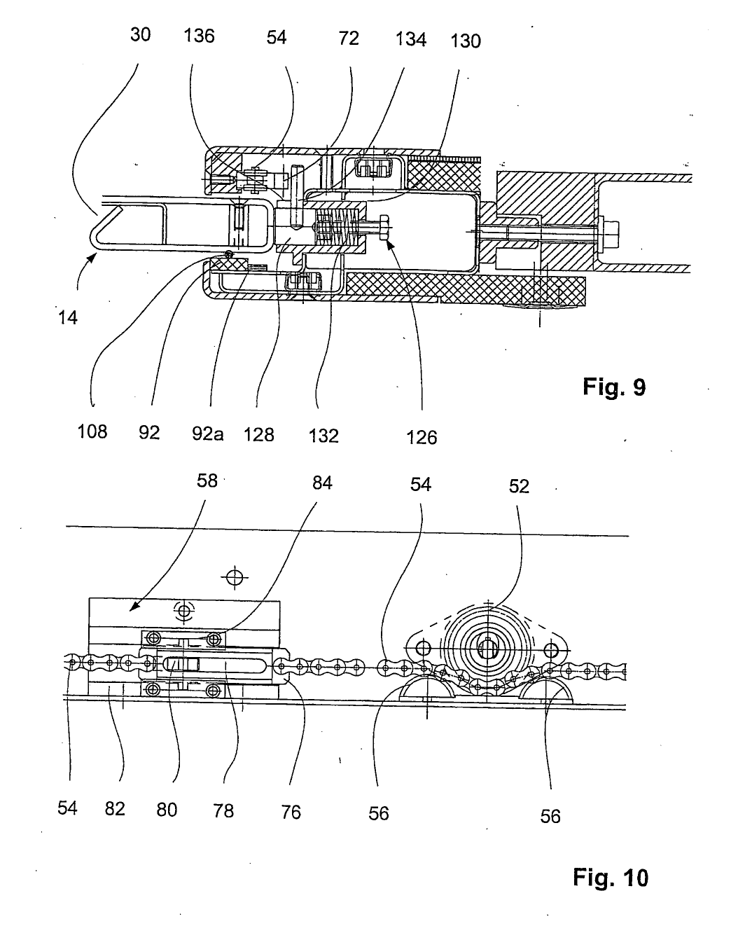

FIG. 9 shows a longitudinal cross section through a longitudinal frame part (stringer) of the frame in the closed position of the door leaf with a blocking device; and

FIG. 10 shows a schematic plan view of the second frame part in the area of the handle, where both a pinion connected to the handle and the motion converter of the locking device with the locking element can be seen.

FIG. 1 shows a perspective view of a sliding door 10 according to the invention. The sliding door 10 consists of a frame 12, a door leaf 14, an upper guide 16, and a lower guide 18.

The lower and upper guides 16, 18 form the upper and lower boundaries of the frame 12. Stiffening stringers 20, 22 are also provided at the sides to connect the upper and lower guides 16, 18 to each other. That is, the lateral stiffening stringer 22 connects the free ends of the upper and lower guides 16, 18 on the right, and the lateral stiffening stringer 20 connects the free ends on the left. The upper and lower guides 16, 18 extend between the two stiffening stringers 20, 22, and the door leaf 14 extends between the upper and lower guides 16, 18.

When the door leaf 14 according to FIG. 1 is located all the way to the left, the frame 12 forms the boundary of a walk-through opening 24. The sliding door 10 is located now in its “open” position.

When the door leaf 14 is all the way to the right in FIG. 1, the door leaf is located completely within the frame 12, and the sliding door 10 is in its “closed” position.

The door leaf 14 is supported in the upper guide 16 and in the lower guide 18 with the freedom to slide between its open position and its closed position.

The door leaf 14 has guide rollers (not shown here), which engage in the upper guide 16 and in the lower guide 18, and which make it possible for the door leaf 14 to slide easily. In addition, the sliding door 10 is produced by methods which ensure that it is light in weight. The door leaf 14 is filled with sound-damping filler material such as plastic honeycomb, which is covered with sound-damping tiles. The surface of the leaf is also provided with material to protect it from mechanical damage.

On the side of the leaf facing the walk-through opening 24, a door handle 26, which can be folded into and out of the door leaf 14, is supported pivotally at its upper end. In its inward-pivoted position, the door handle 26 is flush with the forward edge 28 of the door leaf 14, i.e., the edge facing the walk-through opening 24. As a result, it is easy for a user to grip the door handle 26 and use it to move the door leaf 14 from the open position to the closed position.

The door handle 26 must be folded inward before the door is fully closed in order to prevent the hand of the user from being caught. A recess is therefore introduced into the door leaf 14 on each side of the door leaf 14, adjacent to the door handle 26. These recesses serves as grips 30, which can be used to push the door leaf 14 the rest of the way closed.

On the side facing the door leaf 14, the lateral stiffening stringer 20 has rubber bumpers 32, which interact with the door leaf 14. A stiffening claw 34 is assigned to each of the rubber bumpers 32. These claws are attached to the rear edge 36 of the door leaf 14, i.e., the edge which faces the lateral stiffening stringer 20. The function of the stiffening claws 34 is explained in greater detail below in conjunction with FIG. 6.

The upper and lower guides 16, 18, together with the stiffening stringers 20, 22 and the frame 12, are built into an existing wall, such as the wall of an aircraft. Parts of this wall are extended and tightly sealed to the upper and lower guides 16, 18. One such wall part starts next to the frame 12 and extends to the lateral stiffening stringer 20 in such a way that the area next to the frame 12 in which the door leaf 14 travels will not be obstructed, while at the same time the area in question will be tightly sealed.

FIG. 1 also shows safety sensor 38, which is installed in the area of the frame 12 covering the lateral stiffening stringer 22. This sensor therefore functions on the front side 48 of the sliding door 10. Engagements openings 40 for handles 42, furthermore, are provided in both the front and the rear of the sliding door 10. The handles 42, which serve as part of a locking device for the door leaf 14, can engage in the engagement openings 40 on each side of the frame 12. The handles 42 are designed so that each one has its own separate positive connection with its engagement opening 40 on the side.

FIGS. 2, 5, 7, 8 and 10 shows the locking device, which is mounted in a rear frame part 46 of the frame 12 on what in FIG. 1 appears as the rear surface 44 of the sliding door 10. The front side 48 of the frame 12 has a front frame part 50.

The handles 42 fit into the engagement openings 40 in the frame part 46. As a result, the handles 42 can engage with a pinion 52, which is supported rotatably on the inside surface of the frame part 46. The pinion 52 engages in a link chain 54, which serves as a force-transmitting means. As a result, the movement of a handle 42 can be transmitted via the pinion 52 to the chain 54. So that the area where the pinion 52 engages with the chain 54 can be as large as possible, two guide surfaces 56 are assigned to the pinion, one on each side. These surfaces act on the side of the chain 54 facing away from the pinion 52 and thus have the effect of pushing the chain against the pinion 52 and of guiding the chain 54 during the operation of the device (see FIG. 10).

The chain 54 connects several motion converters 58, which are distributed around the periphery of the frame part 46. All of these converters are designed in the same way. Two motion converters 58 are mounted on the upper transverse stringer 60 of the frame part 46; four converters 58 are mounted on each of the lateral stringers 62 and 64 of the frame part 46; and another two motion converters are mounted on the lower transverse stringer 66 of the frame part 46 (see FIG. 2). In addition, several chain takeups 68 are provided, which are intended to simplify installation and to make it possible to adjust the locking device in such a way that it moves uniformly and continuously between its two end positions.

In the corners of the frame part 46, the chain 54 passes around slide guides 70. In addition, two blocking means 72, 74 are integrated into the course of the chain 54, which will be discussed in greater detail below on the basis of FIGS. 3 and 9.

The motion converter 58 has a slide 76 with two ends, on both of which the chain 54 acts. In the slide there is a recess 78, in which a roller 80 is mounted. The slide 76 is supported with freedom to slide in a housing 82, which is permanently connected to the frame part 46. The roller 80 has an axle 84, which extends from both sides of the roller 80 and engages in a guide link 88 and also in the housing 82 (see FIGS. 6 and 10).

In the direction in which the slide 76 moves, the recess 78 is at least as large as the movement required to move the door leaf 14 from its free position to its hold position. The axle 84 of the roller 80 is mounted in a plane parallel to that of the frame part 46. The axle 84, however, is supported on each side of the roller 80 and of the guide link 88 in a groove 86 in the housing 82, which is perpendicular to the plane of the frame part 46. When the slide 76 is pulled in the one or the other direction, the roller 80 is therefore able to move in a direction perpendicular to that in which it is being moved by the slide (FIG. 6).

As already explained above, the door leaf 14 is locked in its closed position by the use of the handle 42. The rollers 80 of the motion converters 58 serve as the locking elements and when actuated move from a free position, in which the door leaf 14 is not held, into a hold position, in which the door leaf 14 is held in a friction-locking connection with a seal 92. For this purpose, the rollers 80 press the door leaf 14 against an elastomer, which has been inserted into the frame part 50 and which serves as the seal 92.

As a result of the pressure exerted by the rollers 80 of the motion converters 58 on the door leaf 14, a force F, is thus applied to the door leaf 14. The motion converters 58 are supported here against one side 12a of the frame 12, and the door leaf 14 applies the force F, to the seal 92, which has been inserted into the frame part 50 on the other side 12b of the frame 12. A force F₁′, which acts in opposition to the force F₁, therefore acts on the sides 12a and 12b of the frame 12. The force F₁′ presses the sides 12a and 12b of the frame 12 away from each other. To stiffen the frame 12 in particular against these forces F₁′, which are present in the locked state, stiffening means in the form of receptacles in the frame 12 and engagement means on the door leaf 14 are provided, which produce a transverse force F₂, as will be discussed later on.

The rotational movement of the handle 42 proceeds around an angle of 90° from one end position to the other end position. The slide 76 of the motion converter 58 is thus shifted in the one or the other direction. By way of the guide link 88 of the slide 76, through which the axle 84 extending from both sides of the roller 80 passes, the roller 80 is pushed from one end position to the other end position. The two end positions are illustrated in detail in FIGS. 7 and 8.

FIGS. 7 and 8 show cross-sectional views of the housing 82. The slide 76 and the chain 54 are seen from the side. Here the design of the guide link 88 can be seen clearly.

FIG. 7 shows the position which the roller 80 occupies when it is in the free position, i.e., the position in which the door leaf 14 is not being held.

FIG. 8 shows the position which the roller 80 occupies when it is in the hold position, in which it presses the door leaf 14 against the seal 92 of the frame part 50. Before the roller 80 reaches the hold position, it is guided over a slack point 90, so that the user can tell when the hold position has been reached. For this purpose, just before the hold position, the guide link 88 extends downward to a point below that which it will ultimately occupy when in the hold position, as shown in FIG. 8.

The slide 76 is bilaterally symmetric with respect to its direction of movement. The roller 80 with its axle 84 and the groove 86 in the housing 82 are also bilaterally symmetric with respect to their direction of movement.

Several rollers 80 are arranged around a single axis to form both a support and a maintenance-free ball bearing.

The housing 82 has an opening 94 assigned to the roller 80, so that the roller 80 can move unhindered into its free position (see FIG. 7). When in this free position, the roller 80 is completely inside the motion converter 58 and therefore inside the slide 76 and the housing 82.

The housing 82 of each motion converter 58 is screwed to the frame part 46.

FIG. 3 shows a cross section through the frame 12 and the lateral stiffening stringer 22 at the level of the safety sensor 38 with the door leaf in the closed position. The safety sensor 38 comprises a rod 96, the length of which can be adjusted by the use of a thread, and which is connected at one end to a piston 98 and at the other end to a feeler head 100. The piston 98 has a blocking pin 106, which, when in the position shown in FIG. 3, engages in the blocking means 74 and thus blocks the actuating mechanism of the locking device, this mechanism consisting of the chain 54, the pinion 52, and the motion converters 58.

The piston 98 is able to move in the cylinder 104 against the force of the spring 102 from the blocking position shown in FIG. 3 to a position which releases the blocking means 74. Thus the blocking pin 106 will travel completely out of the blocking means 74 and release the actuating mechanism. The safety sensor 38 is moved from the blocking position into the previously described position which releases the actuating mechanism by an object acting against the feeler head 100, such as a sleeping container present in the freight compartment of an aircraft.

FIG. 3 shows a cross section of the two frame parts 46 and 50 of the frame 12, where a groove in the frame part 50 carries the seal 92. The seal 92 has been introduced in the form of a tape. A sealing lip 108, which is attached to the door leaf 14, works in conjunction with the seal 92. This lip is welded to the front surface 48 of the door leaf 14 in the area of the seal 92 and extends all the way around the periphery of the door leaf 14. In addition, the recessed grip 30 and the mounting of the door handle 26 in the door leaf 14 can also be seen.

The lateral stringer 22 is stiffened by longitudinal and transverse plates and can absorb a considerable amount of force, even if these plates are only thin sheets of titanium.

Directly adjacent to the seal 92 is a fire blocker 92a, also extending around the periphery and permanently installed on the frame 12. When exposed to heat, this fire blocker foams up and prevents leaks from developing between the front and rear sides 44, 48 of the door leaf 14 when the door leaf 14 is closed and locked FIG. 4 shows another transverse cross section through the longitudinal stringer 22 and the frame 12 in the closed position of the door leaf 14. We can see here a lever 110, connected to the chain 54; the lever interacts with an electrical signal transmitter (not shown). In cooperation with the electrical signal transmitter, the lever 110 generates a signal when the door leaf 14 has reached its closed position and the door leaf 14 has been completely locked by the locking device. As a result, a monitoring unit installed remotely from the sliding door 10 such as in the cockpit of an aircraft can be used to detect easily whether or not the sliding door 10 is locked.

FIG. 4 also shows how the frame 12 and the lateral stiffening stringer 22 are connected to an additional wall 112.

FIG. 6 shows a transverse cross section at the level of a stiffening claw 34 of the door leaf 12. Here the door leaf 14 is in its closed position. The rear edge 36 of the present inventive door leaf 14 is connected by a strap 114 to the stiffening claw 34. The strap 114 is supported in such a way that it is free to move with respect to the stiffening claw 34 in the directions perpendicular to the sliding direction and perpendicular to the surface of the door leaf 14 but is unable to move with respect to the claw 34 in the sliding direction. The rear edge 36 of the door leaf 14 is screwed to the strap 114.

The stiffening claw 34 of the door leaf 14 has engagement means with bevels 124, which engage with cooperating bevels 122 in receptacles in the frame 12. As previously discussed, a force F₁′ acts in the locked state on the sides 12a and 12b of the frame 12. This force F₁′ presses the sides 12a and 12b away from each other. Because the stiffening claws 34 engage in the receptacles formed by the bevels, a force of reaction is created, which acts transversely to the sliding direction of the door leaf 14 and which thus has the effect of holding the sides 12a and 12b of the frame 12 together. As a result, a nonpositive connection is established between the locking device (consisting of the roller 80 and the motion converter 58), the door leaf 14, the sides 12a, 12b of the frame 12, the bevels 122 of the receptacles in the frame 12, and the bevels 124 of the stiffening claws 34 of the door leaf 14. As a result, the frame 12 is resistant to bending and therefore stiff in the area of the rear edge 36 of the door leaf.

As can be seen clearly in FIG. 6, rollers 118 are provided at the rear of the claw 34; these rollers roll along the inside surfaces 116 of the frame 12 and of the wall 120, which starts at the frame 12 and extends up as far as the lateral stiffening stringer 20. As long as the claws 34 are engaged in the receptacles of the frame 12, they provide the door leaf 14 with additional guidance as it is being pushed from the open position to the closed position and vice versa. This action of the floating claws 34 guarantees that the door leaf is guided securely during the final phase of the closing movement, just before reaching the closed and locked position.

The rollers 118 cooperate with the inside surfaces of the frame 12 to form a first support on one side, and the engagement means of the door leaf 14, designed as bevels 124, and the receptacle means of the frame 12, designed as bevels 122, cooperate to form a second support on the other side. There are thus two supports. The additional forces which occur in the locked state, such as those caused by gas pressures acting on the frame 12 and the door leaf 14, are absorbed essentially by the first support. Because the sides 12a and 12b of the frame 12 are clamped very strongly by the forces F₁′, F₁, and F₂, they are very strong.

The claws 34 with their bevels 124 engage in their assigned bevels 122 of the frame 12. The bevels 122 of the frame 12 and the bevels 124 of the claws are at an angle to a plane which is parallel to the sliding direction of the door leaf, so that, when the leaf is in the closed position, a contact surface of maximum size and strength is obtained. When the leaf is in the closed position, the frame 12 in the area of the longitudinal stringer 62 is stiffened by this design in conjunction with the forces F₁′, F₁, and F₂ generated by the locking device in the locked state. The frame 12 can absorb considerable forces without being deformed.

The play between the strap 114 and the claw 34 is at least equal to the slight offset of the door leaf 14 which occurs when the leaf is being pressed to lock it non-positively in the sliding direction. This slight offset is attributable, for example, to the slight resilience of the seal 92 and to the bridging of the gap present between the sealing lip 108 and the seal 92 in the free position.

The bevels 122 on each of the inside surfaces of the frame in the area of the rear edge 76 of the door leaf 14 and the claws 34 are designed symmetrically with respect to the plane in which the door leaf slides.

As explained above, the force F₁ acting on the door leaf 14 is active only in the locked state, i.e., the state in which the locking device, consisting of the motion converters 58 with the rollers 80, is resting against one side 12a of the frame 12 and the door leaf 14 is being pressed against the seal 92 on the other side 12b of the frame 12. The frame 12 is thus also stiffened only in the locked state.

FIG. 9 shows a blocking device 126, which allows the rollers 80 to move from the free position to the hold position only after the door leaf 14 has reached the completely closed position. The blocking device 126 is provided with a stop piston 128, which is supported with freedom to slide back and forth in a cylinder 130 against the force of a spring 132. The stop piston 128 is connected to a blocking pin 134, which moves along with the stop piston 128 and travels along a groove 136 in the cylinder 130.

FIG. 9 shows the position of the stop piston 128 after it has moved into the cylinder 130 against the force of the spring 132. In this inward position, the blocking pin 134 releases the blocking means 72, which is connected to the chain 54.

The blocking device 126 is important, because it guarantees that the sliding door 10 can be locked only in its closed position. Only in the closed position is it guaranteed that the door leaf 14 will be locked in a leak-proof manner in the frame 12.

The sliding door 10 also has detachable retaining means, which hold the door leaf 14 in the open position. Once a certain force acting on the door leaf in the direction toward the closed position has been overcome it is possible for the door leaf to move freely toward the closed position. These retaining means are known in and of themselves and are therefore not illustrated or described in any further detail here.

The sliding door is preferably used as a safety door, which resists certain gas pressures when in the closed position. The gas pressures in question are in the range of 150-3,500 Pa.

### LIST OF REFERENCE NOS.

10 sliding door
12 frame
12a side of the frame
12b side of the frame
14 door leaf
16 upper guide
18 lower guide
20 lateral stiffening stringer—left
22 lateral stiffening stringer—right
24 walk-through opening
26 door handle
28 forward edge
30 recessed grip
32 rubber bumper
34 stiffening claws
36 rear edge
38 safety sensor
40 engagement hole?
42 handle
44 rear side
46 frame part—second
48 forward side
50 frame part—first
52 pinion
54 chain
56 guide surfaces
58 motion converter
60 upper transverse stringer
62 longitudinal stringer—left
64 longitudinal stringer—right
66 lower transverse stringer
68 chain takeup
70 slide guide
72 blocking means—safety stop
74 blocking means—safety sensor
76 slide
78 opening
80 roller
82 housing
84 axle
86 groove
88 guide link
90 slack point
92 seal
92a fire blocker
94 opening
96 rod
98 piston
100 feeler head
102 spring
104 cylinder
106 blocking pin
108 sealing lip
110 lever
112 additional wall
114 strap
116 inside surface of the frame
118 rollers
120 wall
122 undercut
124 elevations
126 blocking device
128 stop piston
130 cylinder
132 spring
134 blocking spring
136 groove
F₁′ force which acts on sides 12a, 12b of the frame
F₁ force which acts on the door leaf as a result of the locking device
F₂ force which acts between the surfaces 122 and 124

1. Sliding door (10) with a guide (16, 18) for a door leaf (14), which can be moved in the guide between an open position and a closed position, and with a locking device, which locks the door leaf (14) in the closed position by means of a nonpositive connection,
where the locking device comprises:
drive means (42),
force-transmitting means (54), which cooperate with the drive means (42),
locking elements (80), and
motion converters (58), which move the locking elements (80);
where the locking elements (80) are moved from a free position, in which the door leaf (14) is not held, into a hold position, in which the door leaf (14) is held by friction;
where a frame (12) is provided, which, when the door leaf (14) is in the closed position, at least partially covers the edge areas of the door leaf (14) on the first and/or second side (44, 48) of the door leaf (14); and
where, under the action of the force-transmitting means (54) and the drive means (42), the motion converter (58) can be moved in a first direction relative to the periphery of the frame (12), parallel to one side (44, 48) of the door leaf (14), as a result of which it moves the locking elements (80) in a direction perpendicular to the first direction from the free position to the hold position, whereas, when the motion converter is moved in the other peripheral direction, it moves the locking elements from the hold position to the free position,
characterized in that
a slide (76) with a guide link (88) is installed movably in the motion converter (58); in that
the locking element (80) is immobilized in the direction parallel to the plane of the door leaf (14) but is free to move in the direction perpendicular thereto between the free position and the hold position; in that
the locking element (80) is connected to the guide link (88) of the slide in such a way that the guide link (88), upon the movement of the slide (76) in the one peripheral direction or the other, moves the locking element (80) from the free position into the hold position or vice versa.

2. Sliding door according to claim 1, characterized in that the frame (12) has a first frame part (50) assigned to the first side (48) of the door leaf (14); in that stop means (92) for the door leaf (14), acting perpendicular to the sliding direction of the door leaf (14), are provided in the first frame part (50); and in that the locking device presses the door leaf (14), when in the locked state, against the stop means (92), perpendicular to the sliding direction of the door leaf (14), so that the first side of the door leaf (14) rests by a frictional connection against the stop means (92) and is thus locked nonpositively in its closed position.

3. Sliding door according to claim 1, characterized in that the locking elements (80) of the locking device are located in the second frame part (46) assigned to the second side of the door leaf (14), which locking elements press the door leaf (14) against the stop means (92) in the first frame part (44) when the door leaf is locked.

4. Sliding door according to claim 1, characterized in that the frame (12) completely covers the entire peripheral edge area of the first and second sides of the door leaf (14).

5. Sliding door according to claim 4, characterized in that part of the guide (16, 18) is located inside the frame (12).

6. Sliding door according to claim 1, characterized in that the locking elements (80) and the motion converters (58) are located in the second frame part (40).

7. Sliding door according to claim 1, characterized in that the guide link (88) guides the locking element (80) across a slack point (90) just in front of at least one of its end positions.

8. Sliding door according to claim 1, characterized in that the force-transmitting means is designed as a link chain (54), with which the pinion (52) of the drive means (42) engages.

9. Sliding door according to claim 1, characterized in that the locking element is designed as a rotatably supported roller (80).

10. Sliding door according to claim 9, characterized in that the roller (80) is a maintenance-free ball bearing.

11. Sliding door according to claim 1, characterized in that the stop means are provided with a seal (92).

12. Sliding door according to claim 11, characterized in that, when the door leaf (14) is in the closed position and the locking elements (80) are in the hold position, the seal (92) rests on the entire peripheral edge area of the first side of the door leaf (14), so that the first side of the door leaf (14) is completely sealed off from the second side of the door leaf (14).

13. Sliding door according to claim 11, characterized in that the seal (92) consists of elastomeric material.

14. Sliding door according to claim 13, characterized in that, next to the seal (92), a fire blocker (92a) is provided, which prevents leaks from occurring in the seal (92) under the effect of heat and fire.

15. Sliding door according to claim 14, characterized in that the seal (92) is introduced in the form of a tape into a groove located in the first frame part (48).

16. Sliding door according to one of claim 1, characterized in that the door leaf (14) has a sealing lip (108), especially a welded-on metal wire, assigned to the seal (92).

17. Sliding door according to claim 1, characterized in that the frame (12) is made of titanium sheet.

18. Sliding door according to claim 1, characterized in that detachable retaining means are provided, which hold the door leaf (14) in the open position, and which, as soon as a certain force acting on the door leaf (14) toward the closed position is exceeded, allow the door leaf (14) to be moved toward the closed position.

19. Sliding door according to claim 1, characterized in that a safety sensor (38) is provided, which blocks the locking device when an object next to the sliding door (10) is removed.

20. Sliding door according to claim 19, characterized in that the safety sensor (38) has a spring-loaded feeler (96, 98, 100), which is connected to the force-transmitting means, where, when an object is present, the feeler (96, 98, 100) is pushed against the force of the spring (102) to release the force-transmitting means (54), whereas, when no object is present, the safety sensor (38) travels to an end position under the force of the spring and thus blocks the force-transmitting means (54).

21. Sliding door according to claim 1, characterized in that a blocking device (126) is provided, which makes it possible to lock the door leaf (14) only when it is in the closed position.

22. Sliding door according to claim 1, characterized by a design resistant to burn-through according to Airbus Standard ABD 0031.

23. Use of the sliding door (10) according to claim 1 as a safety door, which resists predetermined gas pressures when in the closed position.

24. Use according to claim 23, characterized in that the gas pressures are in the range of 150-3,500 Pa.
